(19) United States
(12) Patent Application Publication
(10) Pub. No.: US 2013/0085839 A1
(43) Pub. Date: Apr. 4, 2013

(54) Mutually Advertising System, Advertisement Distribution Planning Apparatus and Method, and Computer Program

(71) Applicant: JVC KENWOOD Corporation, Yokohama-shi (JP)

(72) Inventor: Tomohiro Azami, Yokohama-shi (JP)

(73) Assignee: JVC KENWOOD CORPORATION, Yokohama-shi (JP)

(21) Appl. No.: 13/628,132

(22) Filed: Sep. 27, 2012

(30) Foreign Application Priority Data
Sep. 30, 2011 (JP) 2011-218412

(51) Int. Cl. G06Q 30/02

(52) U.S. Cl. 705/14.43

(57) ABSTRACT

A mutually advertising system includes an ad distribution planning apparatus and ad indication systems possessed by respective business enterprises. Each of the ad indication systems plays back an ad distributed from the ad distribution planning apparatus. With respect to each of the business enterprises, an ad viewing amount is calculated from the number of viewers about the related ad indication system and a time range during which an ad is played back by the related ad indication system. The calculated ad viewing amount is converted into a conversion-result ad charge according to a prescribed rule. A combined ad charge is calculated from the conversion-result ad charge and a paid ad charge. The ad distribution planning apparatus sets distribution of an ad of each of the business enterprises to the ad indication systems on the basis of the calculated combined ad charge.

### CROSS-REFERENCE TO RELATED APPLICATIONS

This application claims priority from Japanese patent application number 2011-218412, filed on Sep. 30, 2011, the disclosure of which is hereby incorporated by reference.

### BACKGROUND OF THE INVENTION

1. Field of the Invention

This invention relates to a mutually advertising system in which business enterprises mutually provide advertisements (ads) to each other. In addition, this invention relates to advertisement (ad) distribution planning apparatus and method, and a related computer program.

2. Description of the Related Art

In recent years, digital signages have been spread. Usually, digital signages are provided in stores, streets, and transportation facilities.

A typical digital signage includes a display or a projector indicating digital contents related to ads (advertisements). Generally, digital contents are moving pictures. The typical digital signage is advantageous over a conventional still signboard in that the contents of indicated ads can easily be changed and viewers tend to be more interested in indicated ads.

Digital signages can use relatively small displays or projectors. Thus, digital signages are frequently placed in retail stores or small stores.

Japanese patent application publication number 2010-128694 discloses generating an electronic advertisement distribution plan. In Japanese application 2010-128694, ones are selected from among information pieces representative of display spare time ranges for digital signages according to preset conditions, and plan information pieces are generated by grouping the selected information pieces.

Japanese patent application publication number 2008-112401 discloses an advertisement effect measurement apparatus having a first section for photographing an area where an advertisement display is installed, and a second section for recognizing a face image of every person in the photographed area and detecting a person's eye direction from the recognized face image to generate a person face image information piece. The apparatus of Japanese application 2008-112401 further has a third section for measuring the number of persons viewing an advertisement indicated by the display in response to the person face image information pieces generated by the second section. The measured number of persons can be an index of the advertising effect of the advertisement indicated by the display.

Generally, a digital signage in a store continuously plays back ads on a substantially endless basis. The played-back ads can be viewed by only people in or around the store while they can not be viewed by people distant therefrom.

It is conceivable to build a mutually advertising system designed so that business enterprises having respective digital signages distant from each other can mutually provide ads to each other. In an example of operation of such a conceivable system, one business enterprise provides its ad to at least one other business enterprise and allows the provided ad to be indicated by a digital signage of the other business enterprise.

In a conceivable mutually advertising system, it is thought that each business enterprise desires the distribution of greater volumes of its ad to other business enterprises while disliking the use of a digital signage thereof to indicate ads of the other business enterprises. Thus, it is thought that the mutual distribution of ads is inactive and the system cannot work adequately.

### SUMMARY OF THE INVENTION

It is a first object of this invention to provide a mutually advertising system which can dynamize the distribution of advertisements (ads). It is a second object of this invention to provide an advertisement (ad) distribution planning apparatus which enables active distribution of ads.

It is a third object of this invention to provide an ad distribution planning method which enables active distribution of ads.

It is a fourth object of this invention to provide a computer program which enables active distribution of ads.

A first aspect of this invention provides a mutually advertising system comprising an ad distribution planning apparatus; and a plurality of ad indication systems connected with the ad distribution planning apparatus via a network and possessed by business enterprises respectively, wherein each of the ad indication systems plays back an ad distributed from the ad distribution planning apparatus. The ad distribution planning apparatus comprises an ad-viewing-amount calculating section for, with respect to each of the business enterprises, calculating an ad viewing amount from the number of viewers about the ad indication system possessed by the business enterprise and a time range during which an ad is played back by the ad indication system possessed by the business enterprise, and a combined-ad-charge calculating section for, with respect to each of the business enterprises, converting the ad viewing amount calculated by the ad-viewing-amount calculating section into a conversion-result ad charge according to a prescribed rule and calculating a combined ad charge from the conversion-result ad charge and a paid ad charge. The ad distribution planning apparatus further comprises an ad allotting section for setting distribution of an ad of each of the business enterprises to the ad indication systems on the basis of the combined ad charge calculated by the combined-ad-charge calculating section.

A second aspect of this invention provides an ad distribution planning apparatus connected with a plurality of ad indication systems of respective business enterprises via a network, wherein each of the ad indication systems plays back an ad distributed from the apparatus. The apparatus comprises an ad-viewing-amount calculating section for, with respect to each of the business enterprises, calculating an ad viewing amount from the number of viewers about the ad indication system of the business enterprise and a time range during which an ad is played back by the ad indication system of the business enterprise; a combined-ad-charge calculating section for, with respect to each of the business enterprises, converting the ad viewing amount calculated by the ad-viewing-amount calculating section into a conversion-result ad charge according to a prescribed rule and calculating a combined ad charge from the conversion-result ad charge and a paid ad charge; and an ad allotting section for setting distribution of an ad of each of the business enterprises to the ad indication systems on the basis of the combined ad charge calculated by the combined-ad-charge calculating section.

A third aspect of this invention provides a mutually advertising system comprising an ad distribution planning apparatus; and a plurality of ad indication systems connected with the ad distribution planning apparatus via a network and possessed by business enterprises respectively. Each of the ad indication systems comprises a digital signage for indicating an ad distributed from the ad distribution planning apparatus, and a viewing-information collecting section for calculating an ad viewing amount from the number of viewers about an ad indicated by the digital signage and time intervals during which the viewers monitor the ad indicated by the digital signage respectively, and for sending the calculated ad viewing amount to the ad distribution planning apparatus. The ad distribution planning apparatus comprises a combined-ad-charge calculating section for, with respect to each of the business enterprises, converting the ad viewing amount sent from the ad indication system possessed by the business enterprise into a conversion-result ad charge according to a prescribed rule and calculating a combined ad charge from the conversion-result ad charge and a paid ad charge, and an ad allotting section for setting distribution of an ad of each of the business enterprises to the ad indication systems on the basis of the combined ad charge calculated by the combined-ad-charge calculating section.

A fourth aspect of this invention provides an ad distribution planning apparatus connected with a plurality of ad indication systems of respective business enterprises via a network, wherein each of the ad indication systems indicates an ad distributed from the apparatus. The apparatus comprises a viewing-information receiving section for receiving ad viewing amounts from the ad indication systems respectively, wherein each of the viewing amounts depends on the number of viewers about an ad indicated by the related ad indication system and time intervals during which the viewers monitor the ad indicated by the related ad indication system respectively; a combined-ad-charge calculating section for, with respect to each of the business enterprises, converting the related ad viewing amount received by the viewing-information receiving section into a conversion-result ad charge according to a prescribed rule and calculating a combined ad charge from the conversion-result ad charge and a paid ad charge; and an ad allotting section for setting distribution of an ad of each of the business enterprises to the ad indication systems on the basis of the combined ad charge calculated by the combined-ad-charge calculating section.

A fifth aspect of this invention provides a method of planning the distribution of ads. The method comprises the steps of, with respect to each of business enterprises possessing respective ad indication systems for playing back a distributed ad, calculating an ad viewing amount from the number of viewers about the ad indication system possessed by the business enterprise and a time range during which an ad is played back by the ad indication system possessed by the business enterprise; with respect to each of the business enterprises, converting the calculated ad viewing amount into a conversion-result ad charge according to a prescribed rule and calculating a combined ad charge from the conversion-result ad charge and a paid ad charge; and setting distribution of an ad of each of the business enterprises to the ad indication systems on the basis of the calculated combined ad charge.

A sixth aspect of this invention provides a method of planning the distribution of ads. The method comprises the steps of receiving ad viewing amounts from respective ad indication systems of business enterprises, wherein each of the viewing amounts depends on the number of viewers about an ad indicated by the related ad indication system and time intervals during which the viewers monitor the ad indicated by the related ad indication system respectively; with respect to each of the business enterprises, converting the related received ad viewing amount into a conversion-result ad charge according to a prescribed rule and calculating a combined ad charge from the conversion-result ad charge and a paid ad charge; and setting distribution of an ad of each of the business enterprises to the ad indication systems on the basis of the calculated combined ad charge.

A seventh aspect of this invention provides a computer program for enabling an information processing apparatus to function as an ad-viewing-amount calculating section for, with respect to each of business enterprises possessing respective ad indication systems, calculating an ad viewing amount from the number of viewers about the ad indication system of the business enterprise and a time range during which an ad is played back by the ad indication system of the business enterprise; a combined-ad-charge calculating section for, with respect to each of the business enterprises, converting the ad viewing amount calculated by the ad-viewing-amount calculating section into a conversion-result ad charge according to a prescribed rule and calculating a combined ad charge from the conversion-result ad charge and a paid ad charge; and an ad allotting section for setting distribution of an ad of each of the business enterprises to the ad indication systems on the basis of the combined ad charge calculated by the combined-ad-charge calculating section.

An eighth aspect of this invention provides a computer program for enabling an information processing apparatus to function as a viewing-information receiving section for receiving ad viewing amounts from indication systems of business enterprises respectively, wherein each of the viewing amounts depends on the number of viewers about an ad indicated by the related ad indication system and time intervals during which the viewers monitor the ad indicated by the related ad indication system respectively; a combined-ad-charge calculating section for, with respect to each of the business enterprises, converting the related ad viewing amount received by the viewing-information receiving section into a conversion-result ad charge according to a prescribed rule and calculating a combined ad charge from the conversion-result ad charge and a paid ad charge; and an ad allotting section for setting distribution of an ad of each of the business enterprises to the ad indication systems on the basis of the combined ad charge calculated by the combined-ad-charge calculating section.

This invention has the following advantage. In a mutually advertising system designed so that business enterprises mutually provide ads to each other, it is possible to dynamize the distribution of the ads.

### BRIEF DESCRIPTION OF THE DRAWINGS

FIG. 1 is a block diagram of a mutually advertising system according to a first embodiment of this invention.

FIG. 2 is a block diagram of an ad (advertisement) distribution planning apparatus in FIG. 1.

FIG. 3 is a diagram showing an example of the structure of a business enterprise information table in FIG. 2.

FIG. 4 is a diagram showing an example of the structure of an ad information table in FIG. 2.

FIG. 5 is a diagram showing an example of the structure of a distribution information table in FIG. 2.

FIG. 6 is a block diagram of an ad indication system in FIG. 1.

FIG. 7 is a flowchart of plan making operation of the ad distribution planning apparatus in FIG. 2.

FIG. 8A is a diagram showing an example of the relation among business enterprise IDs, total ad playback time lengths, basic viewer numbers, and ad viewing amounts.

FIG. 8B is a diagram showing an example of the relation among business enterprise IDs, ad viewing amounts, and conversion-result ad charges.

FIG. 8C is a diagram showing an example of the relation among business enterprise IDs, paid ad charges, conversion-result ad charges, and combined ad charges.

FIG. 8D is a diagram showing an example of the relation among business enterprise IDs, combined ad charges, and numbers of times of implementation of ad distribution.

FIG. 9 is a block diagram of an ad distribution planning apparatus in a mutually advertising system according to a second embodiment of this invention.

FIG. 10 is a diagram showing an example of the structure of a business enterprise information table in FIG. 9.

FIG. 11 is a diagram showing an example of the structure of a viewing information table in FIG. 9.

FIG. 12 is a block diagram of an ad indication system in the mutually advertising system according to the second embodiment of this invention.

FIG. 13 is a flowchart of operation of the ad indication system in FIG. 12.

FIG. 14 is a flowchart of plan making operation of the ad distribution planning apparatus in FIG. 9.

FIG. 15 is a block diagram of the mutually advertising system according to the second embodiment of this invention.

### DETAILED DESCRIPTION OF THE INVENTION

### First Embodiment

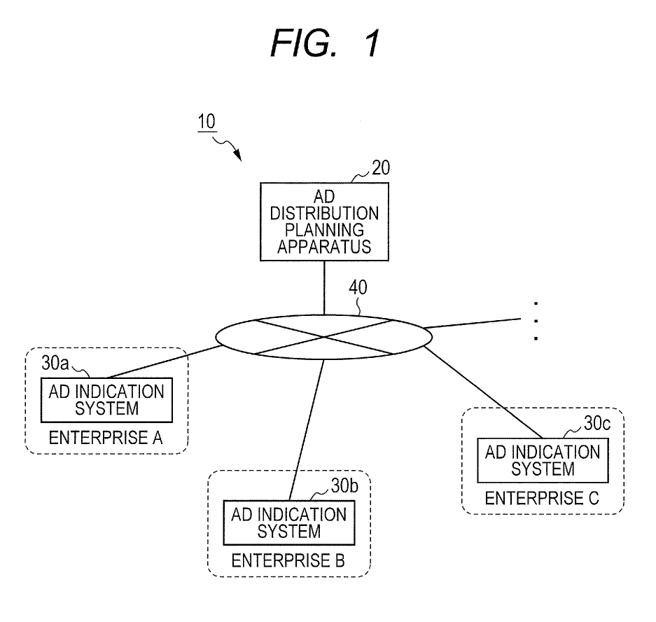

With reference to FIG. 1, a mutually advertising system 10 in a first embodiment of this invention includes an ad (advertisement) distribution planning apparatus 20, and ad indication systems 30 (30a, 30b, 30c, . . . ) which are interconnected by a communication network 40.

Each of the ad indication systems 30a, 30b, 30c, . . . contains at least one digital signage. The digital signage is used to indicate an ad or ads (advertisements). Different IDs are assigned to the ads, respectively.

The ad indication systems 30a, 30b, 30c, . . . are possessed by business enterprises “A”, “B”, “C”, . . . , respectively. Specifically, the ad indication systems 30a, 30b, 30c, . . . are placed in, for example, stores of the business enterprises “A”, “B”, “C”, . . . , respectively. Different IDs are assigned to the business enterprises “A”, “B”, “C”, . . . , respectively.

The ad distribution planning apparatus 20 serves to distribute ads of the business enterprises “A”, “B”, “C”, . . . among the ad indication systems 30a, 30b, 30c, . . . . An administrator of the ad distribution planning apparatus 20 collects ad charges (ad rates) from the business enterprises “A”, “B”, “C”, . . . , and administrates the ad distribution planning apparatus 20 by using the collected ad charges. The ad distribution planning apparatus 20 derives a viewing amount (an audience amount) of an ad indicated by the digital signage in the ad indication system 30 of each of the business enterprises “A”, “B”, “C”, . . . , and converts the viewing amount into an ad charge (a conversion-result ad charge). For each of the business enterprises “A”, “B”, “C”, . . . , the ad distribution planning apparatus 20 distributes an ad of the business enterprise to the ad indication systems 30 a given number of times which is determined by the sum of the ad charge paid by the business enterprise and the conversion-result ad charge relating to the business enterprise. A basic viewer number is introduced as an indication of how many people view a digital signage. The viewing amount of the ad is equal to the product of the basic viewer number for the related digital signage and the total time length of the ad playback by the related digital signage in a prescribed term.

Thus, in the mutually advertising system 10, an ad of a business enterprise is distributed more times as an ad viewing amount relating to the digital signage of the business enterprise is greater. Accordingly, an ad of a business enterprise is distributed more times as the number of people viewing the digital signage of the business enterprise is larger or the total time length of the ad playback by the digital signage is greater.

Thereby, each of the business enterprises “A”, “B”, “C”, . . . is given an incentive to increase the total time length of the ad playback by the digital signage of the business enterprise in order to enable an ad of the business enterprise to be distributed more times. As a result, in the mutually advertising system 10, the distribution of ads can be dynamized. Each of the business enterprises “A”, “B”, “C”, . . . can increase the number of times its ad is distributed by increasing the ad viewing amount relating to its digital signage without increasing the paid ad charge. Thus, each of the business enterprises “A”, “B”, “C”, . . . can save the ad cost.

To each of the ad indication systems 30a, 30b, 30c, . . . , ads of the business enterprises except one having the present ad indication system are distributed via the ad distribution planning apparatus 20. For example, to the ad indication system 30a of the business enterprise “A”, ads of the business enterprises “B”, “C”, . . . are distributed. The digital signage in each of the ad indication systems 30a, 30b, 30c, . . . indicates and play backs ads of the corresponding business enterprise during normal ranges of time, and indicates and plays back ads of the other business enterprises (that is, ads distributed via the ad distribution planning apparatus 20) during given ranges of time between the normal ranges. It should be noted that an ad of each of the business enterprises “A”, “B”, “C”, . . . may be distributed to its own ad indication system also via the ad distribution planning apparatus 20.

In the mutually advertising system 10, each of the business enterprises “A”, “B”, “C”, . . . functions as an ad distribution destination in which a digital signage in a store plays back distributed ads of the other business enterprises. Furthermore, each of the business enterprises “A”, “B”, “C”, . . . functions as an advertiser being a provider for an ad played back by the digital signages of the other business enterprises. An advertiser business enterprise may dispense with a digital signage.

Preferably, the ad distribution planning apparatus 20 is formed by an information processing apparatus such as a server computer or a personal computer. The information processing apparatus includes a combination of a CPU, memories, a hard disk device, input/output interfaces, a communication device, and other devices. The information processing apparatus operates in accordance with a computer program stored in one of the memories and the hard disk device.

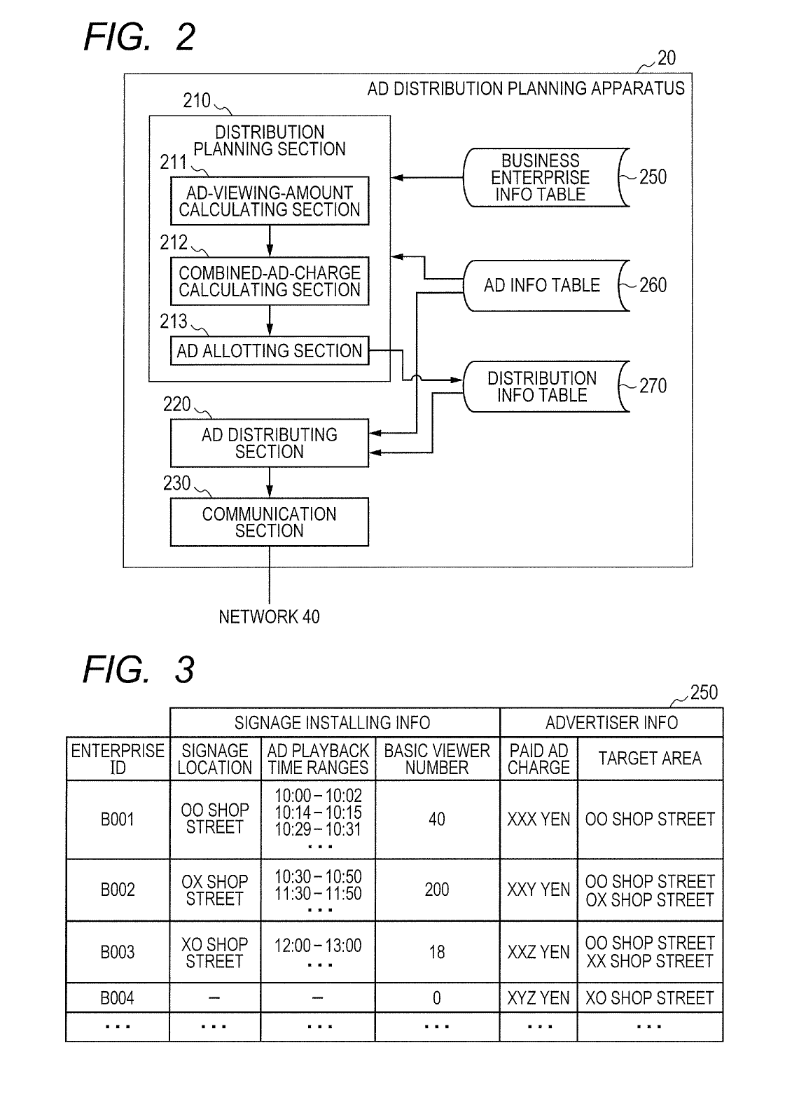

With reference to FIG. 2, the ad distribution planning apparatus 20 includes a distribution planning section 210, an ad distributing section 220, a communication section 230, a business enterprise information table 250, an ad information table 260, and a distribution information table 270. Preferably, the computer program for the information processing apparatus is designed to enable the ad distribution planning apparatus 20 to implement the sections 210 and 220. Generally, the communication section 230 is formed by the input/output interfaces. Each of the tables 250-270 is provided in one of the memories or the hard disk device.

The distribution planning section 210 makes a plan or scheme for distribution of ads to the business enterprises “A”, “B”, “C”, . . . , and stores the made scheme in the distribution information table 270. To implement this operation, the distribution planning section 210 includes an ad-viewing-amount calculating section 211, a combined-ad-charge calculating section 212, and an ad allotting section 213.

The ad-viewing-amount calculating section 211 calculates an ad viewing amount for each of the business enterprises “A”, “B”, “C”, . . . by referring to the business enterprise information table 250. The ad-viewing-amount calculating section 211 notifies the calculated ad viewing amount to the combined-ad-charge calculating section 212. The ad viewing amount results from evaluating how many people view the digital signage of the related business enterprise. Preferably, the ad viewing amount is equal to the product of the basic viewer number for the digital signage and the total time length of the ad playback by the digital signage in a prescribed term such as one day or one week. The basic viewer number is a mean viewer number per unit time during the playback of an ad by the digital signage. The basic viewer number may use an estimated mean viewer number or an actual mean viewer number.

For each of the business enterprises “A”, “B”, “C”, . . . , the combined-ad-charge calculating section 212 calculates a combined ad charge from the ad viewing amount calculated by the ad-viewing-amount calculating section 211 and the paid ad charge stored in the business enterprise information table 250. The combined-ad-charge calculating section 212 notifies the calculated combined ad charge to the ad allotting section 213. Preferably, the combined-ad-charge calculating section 212 converts the ad viewing amount into an ad charge (a conversion-result ad charge). The combined-ad-charge calculating section 212 calculates the sum of the paid ad charge and the conversion-result ad charge, and labels the calculated sum as the combined ad charge.

The ad allotting section 213 allots ads of the business enterprises “A”, “B”, “C”, . . . to distribution destinations on the basis of the combined ad charges calculated by the combined-ad-charge calculating section 212. The ad allotting section 213 stores the result of the allotment into the distribution information table 270. The ad allotting section 213 carries out the allotment by referring to the business enterprise information table 250 and the ad information table 260. The allotment by the ad allotting section 213 is designed so that an ad of each of the business enterprises “A”, “B”, “C”, . . . will be distributed a number of times depending on the corresponding combined ad charge. Alternatively, the allotment may be designed so as to distribute an ad of each of the business enterprises “A”, “B”, “C”, . . . which has a playback time length depending on the corresponding combined ad charge.

The ad distributing section 220 implements a process of distributing ads to the ad indication systems 30a, 30b, 30c, . . . in the business enterprises “A”, “B”, “C”, . . . through the communication section 230 and the communication network 40 while referring to the ad information table 260 and the distribution information table 270. Preferably, the ad distributing section 220 distributes ads on a real-time basis. In this case, an ad to be played back by the business enterprise “A” at 10:00:00 is distributed to the business enterprise “A” from the ad distributing section 220 at 10:00:00. A time lag may be considered for the distribution of the ad. Each ad may be distributed in advance while the time for which the ad should be played back is designated.

The communication section 230 communicates with the ad indication systems 30a, 30b, 30c, . . . in the business enterprises “A”, “B”, “C”, . . . through the communication network 40.

The business enterprise information table 250 stores information having pieces relating to the business enterprises “A”, “B”, “C”, . . . respectively. FIG. 3 shows an example of the structure of the business enterprise information table 250 in which signage installing information and advertiser information are stored for each of the IDs (BOO1, BOO2, BOO3, . . . ) of the business enterprises “A”, “B”, “C”, . . . . The signage installing information relates to a side indicating an ad while the advertiser information relates to a side providing an ad.

The ad indication systems 30a, 30b, 30c, . . . are in a one-to-one correspondence with the business enterprises “A”, “B”, “C”, . . . respectively. Thus, the ad indication systems 30a, 30b, 30c, . . . can be identified by using the business enterprise IDs (BOO1, BOO2, BOO3, . . . ) in the business enterprise information table 250.

As shown in FIG. 3, for each of the IDs (BOO1, BOO2, BOO3, . . . ) of the business enterprises “A”, “B”, “C”, . . . , the signage installing information has a first segment indicating the location of the related digital signage, a second segment indicating a list of time ranges during which a distributed ad or ads can be played back by the related digital signage, and a third segment indicating a basic viewer number for the related digital signage. The foregoing time ranges are called ad playback time ranges.

The location of a digital signage is, for example, a name of a shopping street where the digital signage is located. The location of a digital signage may be an address, an administrative district, or another. The location of a digital signage is called a digital-signage location.

For example, the digital signage of the business enterprise “A” identified by an ID of BOO1 plays back an ad or ads of the business enterprise “A” for normal time ranges, and can be used to play back an ad or ads of one or more other business enterprises, which are distributed via the ad distribution planning apparatus 20, for given time ranges (ad playback time ranges) different from the normal time ranges. For example, the ad playback time ranges are expressed as 10:10˜10:02, 10:14˜10:15, 10:29˜10:31, . . . . There may be a set of ad playback time ranges for a weekday and another set for Saturday, Sunday, and a holiday. The ad playback time ranges may be in selected one or ones of the days of the week only.

Each of the business enterprises “A”, “B”, “C”, . . . notifies the ad playback time ranges concerning the corresponding digital signage to the administrator of the ad distribution planning apparatus 20. As the sum of the lengths of the ad playback time ranges concerning a digital signage of a business enterprise is greater, an ad or ads of one or more other business enterprises can be played back by the digital signage for a longer time. Consequently, the ad distribution can be dynamized.

In the case where each of the business enterprises “A”, “B”, “C”, . . . has only one digital signage, a basic viewer number is given for each digital signage or each business enterprise. The basic viewer number is a mean number of people viewing an ad played back by the digital signage per hour. For example, a basic viewer number of 40 denotes that there are 40 viewers on average for the digital signage when an ad is played back by the digital signage for one hour. For a business enterprise having a plurality of digital signages, the basic viewer number for the business enterprise is equal to the sum of mean viewer numbers for the respective digital signages. The basic viewer numbers in the business enterprise information table 250 use estimated numbers or actual numbers.

Generally, each basic viewer number depends on the environments of the location of the related digital signage and the number of customers of a store where the digital signage is placed. An ad distributed to a business enterprise with a greater basic viewer number is viewed by more people. Thus, the advertising effect can be increased by the distribution of an ad to business enterprises with great basic viewer numbers. Therefore, the basic viewer number denotes the value or worth of the distribution of an ad to the related business enterprise.

The advertiser information relates to each business enterprise operating as an advertiser for providing an ad or ads.

As shown in FIG. 3, for each of the IDs (BOO1, BOO2, BOO3, . . . ) of the business enterprises “A”, “B”, “C”, . . . , the advertiser information has a first segment indicating a paid ad charge, and a second segment indicating an area or areas to which an ad or ads should be provided. The area or areas are called a target area or areas. The paid ad charge contains a system use fee paid to the administrator of the ad distribution planning apparatus 20, and fees paid to other business enterprises for distribution of the ad or ads thereto.

In FIG. 3, the target area or areas for each of the IDs (BOO1, BOO2, BOO3, . . . ) of the business enterprises “A”, “B”, “C”, . . . are places to which the ad or ads should be provided or distributed. The ad or ads are actually distributed to a digital signage or signages in the target area or areas. The target area or areas are designed to be in a correspondence with the digital-signage location or locations. The target area or areas can be set by a request from the related business enterprise.

With reference to FIG. 3, for the business enterprise having an ID of BOO4, the signage installing information is absent while the advertiser information is present. This means that the business enterprise “BOO4” dispenses with a digital signage and becomes an advertiser by paying the ad charge.

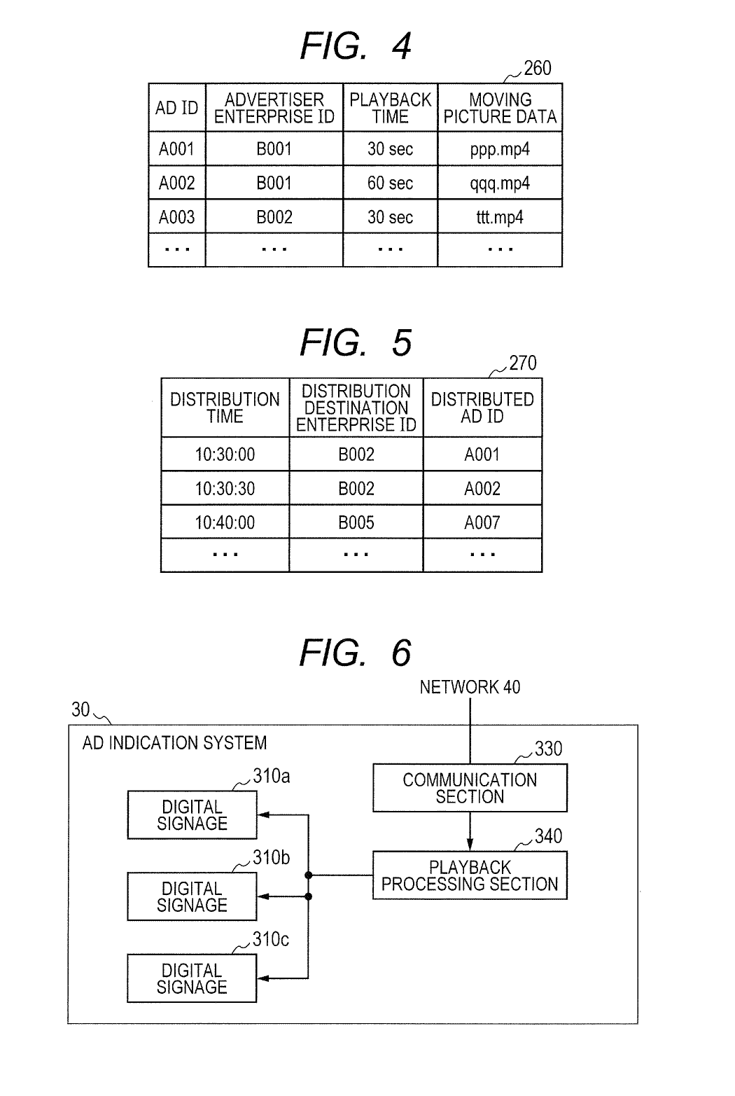

The ad information table 260 stores information about an ad or ads provided by the business enterprises “A”, “B”, “C”, . . . . FIG. 4 shows an example of the structure of the ad information table 260 in which, for each of the IDs of ads, the stored information has a first segment indicating the ID of a business enterprise being an advertiser providing the present ad, a second segment indicating a playback time (playback time length) for the present ad, and a third segment occupied by moving picture data representative of the present ad. The advertiser business-enterprise ID is the ID of a business enterprise providing the ad as an advertiser. The playback time means a time interval for which the ad should be played back. The moving picture data represents the ad to be played back by a digital signage or signages. It should be noted that one business enterprise may provide ads.

The distribution information table 270 stores information indicating a schedule of the distribution of ads to the business enterprises “A”, “B”, “C”, . . . . FIG. 5 shows an example of the structure of the distribution information table 270 in which the stored information represents sets each of distribution time, the ID of a business enterprise being a distribution destination, and the ID of an ad to be distributed. As shown in FIG. 5, the sets are arranged in the order of distribution time. The ad distributing section 220 refers to each of the sets in the distribution information table 270, and thereby identifies an ad and a business enterprise in accordance with the ad ID and the distribution-destination business-enterprise ID in the set and distributes the identified ad to the ad indication system 30 of the identified business enterprise at a moment equal to the distribution time in the set. The ad distributing section 220 acquires the identified ad from the ad information table 260. Preferably, the distributed ad contains not only moving pictures but also the ID thereof.

With reference to FIG. 6, each ad indication system 30 includes digital signages 310 (310a, 310b, and 310c), a communication section 330, and a playback processing section 340. It should be noted that the ad indication system 30 may have only one digital signage 310.

Each digital signage 310 includes a display or a projector, and indicates digital contents such as an ad on the display or the projector. Preferably, the digital signages 310 in the ad indication system 30 simultaneously play back a same ad.

The communication section 330 performs a process for communications with the ad distribution planning apparatus 20 via the communication network 40.

The playback processing section 340 receives, via the communication section 330, data (digital data) representing an ad distributed from the ad distribution planning apparatus 20. The playback processing section 340 subjects the received data to signal processing for ad playback to generate processing-resultant data, and feeds the processing-resultant data to the digital signages 310a, 310b, and 310c. The playback processing section 340 controls the digital signages 310a, 310b, and 310c to indicate the ad represented by the processing-resultant data.

The ad-playback signal processing by the playback processing section 340 includes, for example, converting the data representative of the received ad into a format suited for indication by the digital signage or signages 310. In the case where an ad is distributed in advance while the time during which the ad should be played back is designated, the ad-playback signal processing by the playback processing section 340 may further include feeding data representative of the ad to the digital signage or signages 310 at the designated playback time.

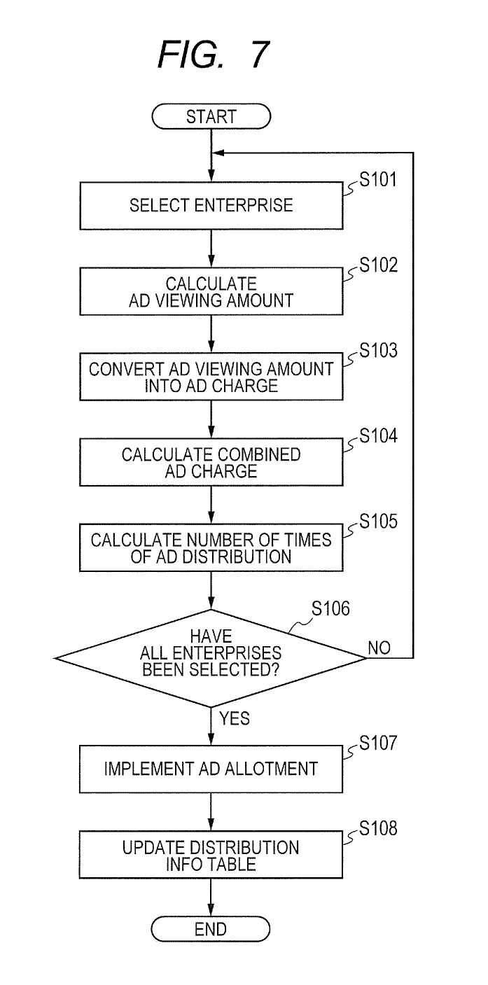

A description will be given below of operation of the ad distribution planning apparatus 20 for making an ad distribution plan or scheme. The ad distribution planning apparatus 20 operates in accordance with the computer program stored therein. FIG. 7 is a flowchart of the plan making operation of the ad distribution planning apparatus 20 which is implemented by a segment of the computer program. Preferably, the plan making operation is started when the business enterprise information table 250 is updated. Alternatively, the plan making operation may be performed periodically, for example, weekly.

With reference to FIG. 7, the first step S101 of the plan making operation selects one from the business enterprises “A”, “B”, “C”, . . . . The step S101 is designed to sequentially select the business enterprises “A”, “B”, “C”, . . . as it is iterated. A step S102 following the step S101 calculates an ad viewing amount for the selected business enterprise by referring to the business enterprise information table 250.

Specifically, for the selected business enterprise, the step S102 calculates the sum of the lengths of the related ad playback time ranges in the business enterprise information table 250 during a prescribed term such as one day or one week. For the selected business enterprise, the step S102 multiplies the calculated sum by the related basic viewer number in the business enterprise information table 250. The step S102 labels the result of the multiplication as the ad viewing amount for the selected business enterprise. In the case where the prescribed term is one week, the ad viewing amount reflects the total ad playback time length in one week.

A step S103 following the step S102 converts the ad viewing amount for the selected business enterprise into a conversion-result ad charge according to a prescribed rule. For example, the step S103 multiplies the ad viewing amount by a prescribed coefficient to obtain the conversion-result ad charge for the selected business enterprise. In this case, the prescribed coefficient is chosen to make a proper balance between the conversion-result ad charge and the ad charge paid by the advertiser.

A step S104 subsequent to the step S103 calculates a combined ad charge from the conversion-result ad charge and the paid ad charge in the business enterprise information table 250 for the selected business enterprise. Preferably, the combined ad charge is equal to the sum of the conversion-result ad charge and the paid ad charge.

A step S105 following the step S104 calculates the number of times of implementation of ad distribution from the combined ad charge for the selected business enterprise. Preferably, the number of times of implementation of ad distribution increases as the combined ad charge rises. The number calculation may be designed so that ad distribution will be implemented once per 500 yen in the combined ad charge.

A step S106 subsequent to the step S105 decides whether or not all the business enterprises “A”, “B”, “C”, . . . have been selected by the step S101. When all the business enterprises “A”, “B”, “C”, . . . have been selected, the operation advances from the step S106 to a step S107. Otherwise, the operation returns from the step S106 to the step S101.

The step S107 implements ad allotment for each of advertiser business enterprises by referring to the calculated number of times of implementation of ad distribution, the ad playback time ranges in the business enterprise information table 250, and the ad information table 260. A step S108 following the step S107 updates the distribution information table 270 in accordance with the implemented ad allotment. After the step S108, the plan making operation ends.

In the plan making operation, the ad-viewing-amount calculating section 211 selects one from the business enterprises “A”, “B”, “C”, . . . (the step S101). Then, the ad-viewing-amount calculating section 211 calculates an ad viewing amount for the selected business enterprise by referring to the business enterprise information table 250 (the step S102).

Specifically, for the selected business enterprise, the ad-viewing-amount calculating section 211 calculates the sum of the lengths of the related ad playback time ranges in the business enterprise information table 250 during a prescribed term such as one day or one week. For the selected business enterprise, the ad-viewing-amount calculating section 211 multiplies the calculated sum by the related basic viewer number in the business enterprise information table 250. The ad-viewing-amount calculating section 211 labels the result of the multiplication as the ad viewing amount for the selected business enterprise. In the case where the prescribed term is one week, the ad viewing amount reflects the total ad playback time length in one week.

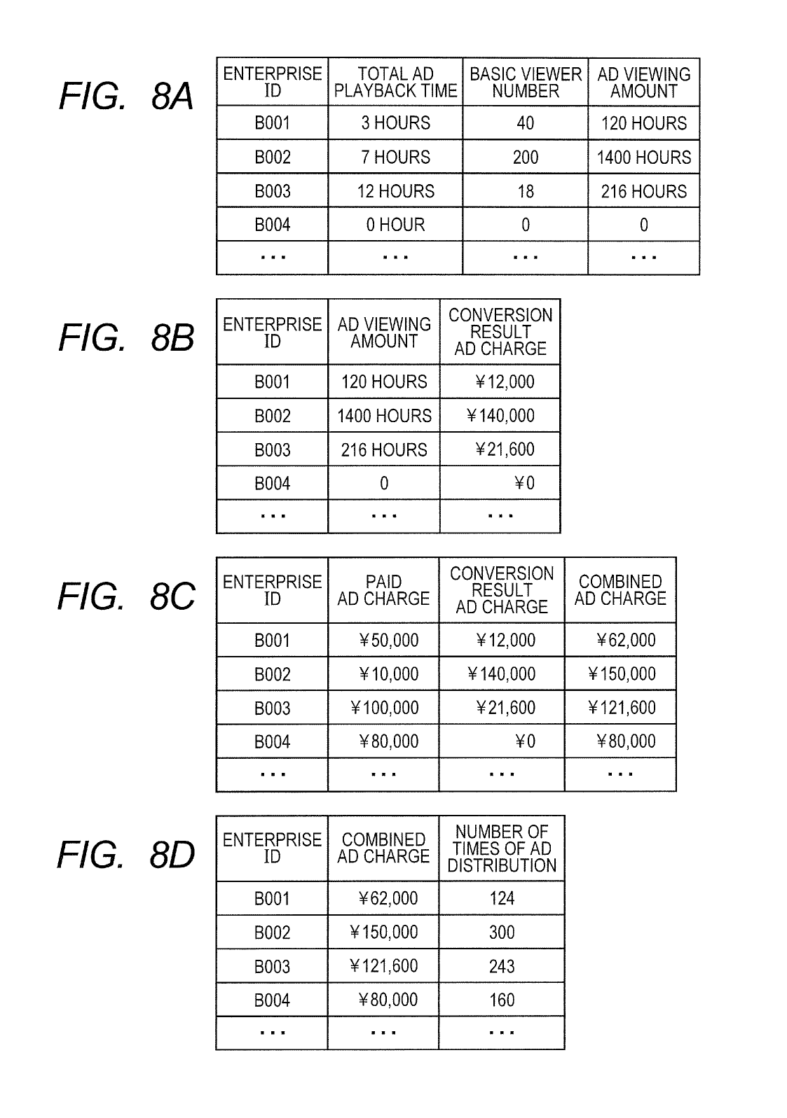

With reference to FIG. 8A, for a business enterprise having an ID of “BOO1”, the total ad playback time length in one week is 3 hours and the basic viewer number is 40. Thus, for the business enterprise “BOOO1”, the ad viewing amount is 120 hours (3 hours by 40).

The combined-ad-charge calculating section 212 converts the ad viewing amount for the selected business enterprise into a conversion-result ad charge according to a prescribed rule (the step S103). For example, the combined-ad-charge calculating section 212 multiplies the ad viewing amount by a prescribed coefficient to obtain the conversion-result ad charge for the selected business enterprise. In this case, the prescribed coefficient is chosen to make a proper balance between the conversion-result ad charge and the ad charge paid by the advertiser.

With reference to FIG. 8B, for a business enterprise having an ID of “BOO1”, an ad viewing amount of 120 hours is multiplied by a coefficient of 100 to calculate a conversion-result ad charge of 12000 yen (120 by 100 yen).

The combined-ad-charge calculating section 212 calculates a combined ad charge from the conversion-result ad charge and the paid ad charge in the business enterprise information table 250 for the selected business enterprise (the step S104). Preferably, the combined ad charge is equal to the sum of the conversion-result ad charge and the paid ad charge.

With reference to FIG. 8C, for a business enterprise having an ID of “BOO1”, a paid ad charge of 50000 yen and a conversion-result ad charge of 12000 yen are summed to calculate a combined ad charge of 62000 yen.

The ad allotting section 213 calculates the number of times of implementation of ad distribution from the combined ad charge for the selected business enterprise (the step S105). Preferably, the number of times of implementation of ad distribution increases as the combined ad charge rises. The number calculation may be designed so that ad distribution will be implemented once per 500 yen in the combined ad charge.

The above-mentioned actions by the ad-viewing-amount calculating section 211, the combined-ad-charge calculating section 212, and the ad allotting section 213 are iterated while the selected business enterprise is repetitively changed from one to another (the steps S106 and S101). Thus, the above-mentioned actions are implemented with respect to all the business enterprises “A”, “B”, “C”, . . . . Accordingly, the number of times of implementation of ad distribution is calculated for each of the advertisers formed by the business enterprises “A”, “B”, “C”, . . . respectively.

Consequently, as shown in FIG. 8D, the numbers of times of implementation of ad distribution are set for the business enterprises “A”, “B”, “C”, . . . respectively. In FIG. 8C, a business enterprise having an ID of BOO2 is low in paid ad charge and high in conversion-result ad charge. As shown in FIG. 8D, the business enterprise “BOO2” is assigned a large number of times of implementation of ad distribution. Thus, even a business enterprise low in paid ad charge is assigned a large number of times of implementation of ad distribution provided that the business enterprise is large in ad viewer number and hence great in ad viewing amount. Accordingly, such a business enterprise can save the ad cost.

In FIG. 8C, a business enterprise having an ID of BOO3 is high in paid ad charge and low in conversion-result ad charge. As shown in FIG. 8D, the business enterprise “BOO3” is assigned a large number of times of implementation of ad distribution. Thus, even a business enterprise low in conversion-result ad charge is assigned a large number of times of implementation of ad distribution provided that the business enterprise is high in paid ad charge. Accordingly, such a business enterprise enables its ad to be indicated by the digital signages 310 of other business enterprises with great viewer numbers, and is hence able to have a great advertising effect.

In this way, the ad indication systems 30 have utility values for not only business enterprises small in ad viewer number but also business enterprises great in ad viewer number. To increase the ad viewing amount, each business enterprise desires to extend the ad playback time ranges. Therefore, it is possible to dynamize the distribution of the ads.

The ad allotting section 213 implements ad allotment for each of advertiser business enterprises by referring to the calculated number of times of implementation of ad distribution, the ad playback time ranges in the business enterprise information table 250, and the ad information table 260 (the step S107). Then, the ad allotting section 213 updates the distribution information table 270 in accordance with the implemented ad allotment (the step S108). Thereafter, the plan making operation ends.

It is sufficient that the implemented ad allotment reflects the numbers of times of implementation of ad distribution which are calculated by the step S105. The ad allotment may be implemented in one of various ways or one of prior-art ways. An example of implementation of ad allotment is as follows. One is selected from the business enterprises “A”, “B”, “C”, . . . . Distribution-destination business enterprises with respect to the selected business enterprise are detected by referring to the business enterprise information table 250. The scheduled time intervals during which an ad of the selected business enterprise should be distributed the calculated number of times are placed into unoccupied ad playback time ranges in each of the distribution-destination business enterprise. These actions are iterated while the selected business enterprise is repetitively changed from one to another. Consequently, ad allotment for all the business enterprises “A”, “B”, “C”, . . . is completed.

As previously described, in the mutually advertising system 10, the business enterprises “A”, “B”, “C”, . . . mutually provide ads to each other. According to the mutually advertising system 10, it is possible to dynamize the ad distribution.

### Second Embodiment

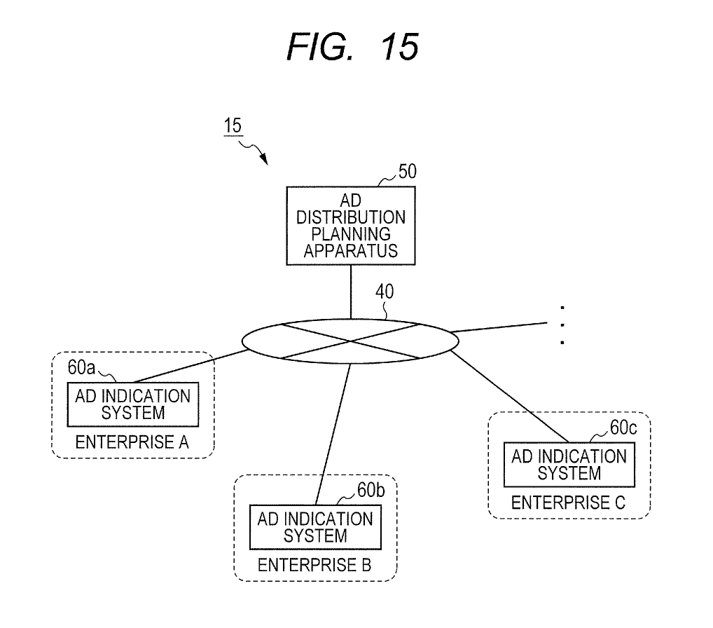

FIG. 15 shows a mutually advertising system 15 according to a second embodiment of this invention. The mutually advertising system 15 is similar to the mutually advertising system 10 of FIG. 1 except that an ad distribution planning apparatus 50 replaces the ad distribution planning apparatus 20, and ad indication systems 60 (60a, 60b, 60c, . . . ) replace the ad indication systems 30 (30a, 30b, 30c, . . . ) respectively. Business enterprises “A”, “B”, “C”, . . . have the ad indication systems 60a, 60b, 60c, . . . respectively.

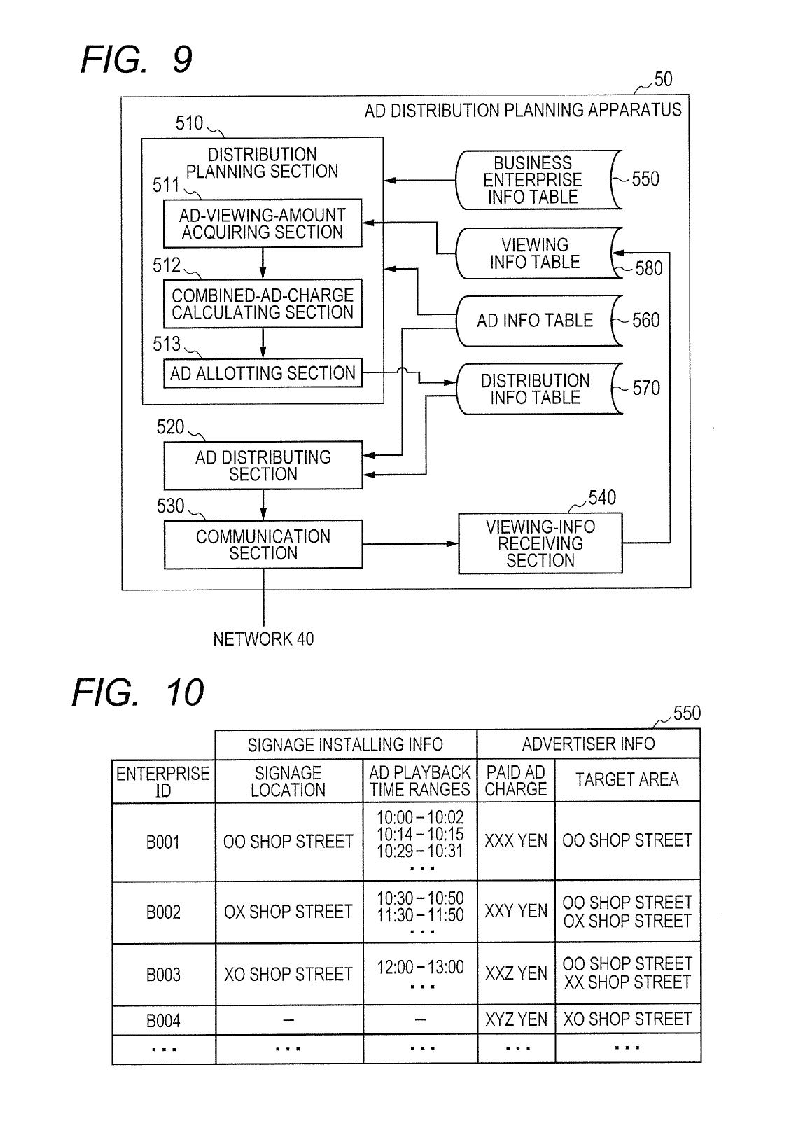

With reference to FIG. 9, the ad distribution planning apparatus 50 includes a distribution planning section 510, an ad distributing section 520, a communication section 530, a viewing-information receiving section 540, a business enterprise information table 550, an ad information table 560, a distribution information table 570, and a viewing information table 580. The ad distributing section 520, the communication section 530, the ad information table 560, and the distribution information table 570 are similar to the ad distributing section 220, the communication section 230, the ad information table 260, and the distribution information table 270 in FIG. 2, respectively.

Preferably, the ad distribution planning apparatus 50 is formed by an information processing apparatus such as a server computer or a personal computer. The information processing apparatus includes a combination of a CPU, memories, a hard disk device, input/output interfaces, a communication device, and other devices. The information processing apparatus operates in accordance with a computer program stored in one of the memories and the hard disk device. Preferably, the computer program for the information processing apparatus is designed to enable the ad distribution planning apparatus 50 to implement the sections 510, 520, and 540. Generally, the communication section 530 is formed by the input/output interfaces. Each of the tables 550-580 is provided in one of the memories or the hard disk device.

The distribution planning section 510 makes a plan or scheme for distribution of ads to the business enterprises “A”, “B”, “C”, . . . , and stores the made scheme in the distribution information table 570. To implement this operation, the distribution planning section 510 includes an ad-viewing-amount acquiring section 511, a combined-ad-charge calculating section 512, and an ad allotting section 513. The combined-ad-charge calculating section 512 and the ad allotting section 513 are similar to the combined-ad-charge calculating section 212 and the ad allotting section 213 in FIG. 2, respectively.

The ad-viewing-amount acquiring section 511 acquires an ad viewing amount for each of the business enterprises “A”, “B”, “C”, . . . by referring to the viewing information table 580. The ad-viewing-amount acquiring section 511 notifies the acquired ad viewing amount to the combined-ad-charge calculating section 512. The ad viewing amount results from evaluating the amount of viewing of an ad indicated by the digital signage of the related business enterprise. Preferably, the ad indication system 60 in the related business enterprise detects viewers about the ad indicated by the digital signage and measures a time interval (an ad-viewed time interval) for which each of the detected viewers monitors the indicated ad. For all the detected viewers, the ad indication system 60 sums the ad-viewed time intervals in a prescribed term such as one day or one week to obtain a total ad-viewed time. The ad indication system 60 sends a viewing information piece representative of the obtained total ad-viewed time to the ad distribution planning apparatus 50 before the viewing information piece is stored into the viewing information table 580 as an indication of the ad viewing amount.

The viewing-information receiving section 540 receives viewing information pieces from the ad indication systems 60a, 60b, 60c, . . . in the business enterprises “A”, “B”, “C”, . . . respectively through the communication section 530. The viewing-information receiving section 540 adds, to the received viewing information pieces, the IDs of the corresponding business enterprises “A”, “B”, “C”, . . . respectively before storing the ID-added viewing information pieces into the viewing information table 580.

The business enterprise information table 550 stores information having pieces relating to the business enterprises “A”, “B”, “C”, . . . respectively. FIG. 10 shows an example of the structure of the business enterprise information table 550 in which signage installing information and advertiser information are stored for each of the IDs (BOO1, BOO2, BOO3, . . . ) of the business enterprises “A”, “B”, “C”, . . . . The signage installing information relates to a side indicating an ad while the advertiser information relates to a side providing an ad.

The ad indication systems 60a, 60b, 60c, . . . are in a one-to-one correspondence with the business enterprises “A”, “B”, “C”, . . . respectively. Thus, the ad indication systems 60a, 60b, 60c, . . . can be identified by using the business enterprise IDs (BOO1, BOO2, BOO3, . . . ) in the business enterprise information table 550.

As shown in FIG. 10, for each of the IDs (BOO1, BOO2, BOO3, . . . ) of the business enterprises “A”, “B”, “C”, . . . , the signage installing information has a first segment indicating the location of the related digital signage, and a second segment indicating a list of time ranges (ad playback time ranges) during which a distributed ad or ads can be played back by the related digital signage. For each of the IDs (BOO1, BOO2, BOO3, . . . ) of the business enterprises “A”, “B”, “C”, . . . , the advertiser information has a first segment indicating a paid ad charge, and a second segment indicating an area or areas (a target area or areas) to which an ad or ads should be provided.

Thus, the business enterprise information table 550 is similar to the business enterprise information table 250 in FIG. 3 except that a third segment indicating a basic viewer number is omitted from the signage installing information for each of the business enterprises “A”, “B”, “C”, . . . . The ad distribution planning apparatus 50 acquires the ad viewing amounts from the ad indication systems 60 without using the basic viewer numbers.

The viewing information table 580 stores information about viewing amounts of respective ads which were played back by the digital signages of the business enterprises “A”, “B”, “C”, . . . . The ad viewing amounts are obtained by the ad indication systems 60 of the business enterprises “A”, “B”, “C”, . . . before being sent to the ad distribution planning apparatus 50.

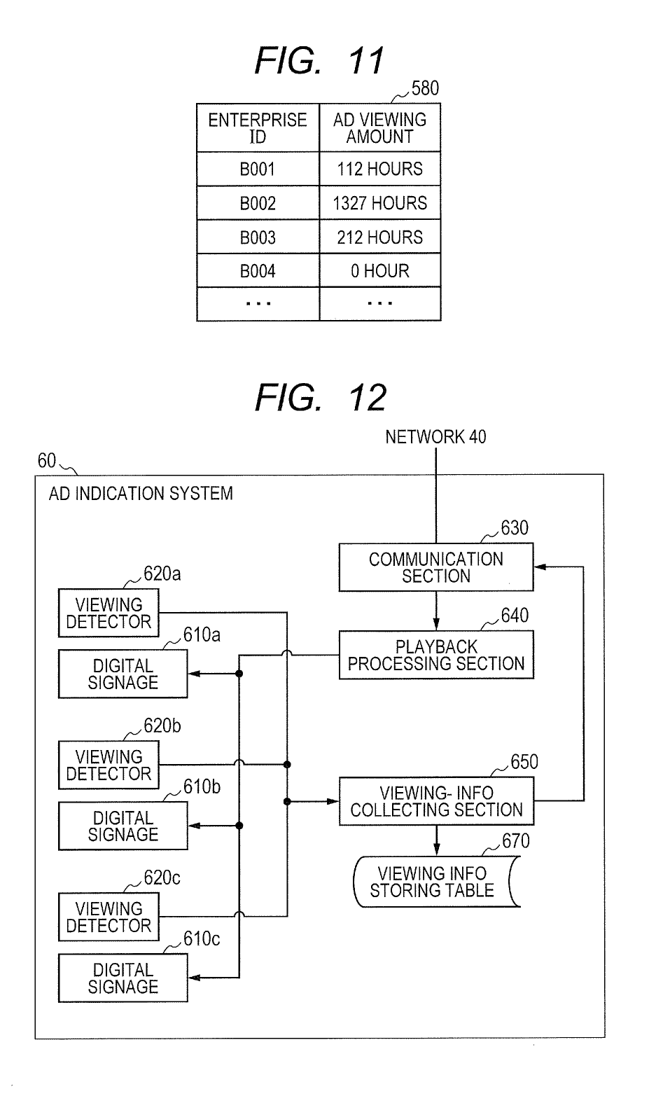

FIG. 11 shows an example of the structure of the viewing information table 580 in which the stored information represents pairs each of the ID of a business enterprise possessing a digital signage which played back an ad, and a total ad-viewed time (an ad viewing amount) regarding the played-back ad. In FIG. 11, the viewing amount of an ad played back by the digital signage of a business enterprise having an ID of BOO1 is equal to 112 hours. The viewing amount of an ad played back by the digital signage of a business enterprise having an ID of BOO2 is equal to 1327 hours.

With reference to FIG. 12, each ad indication system 60 includes digital signages 610 (610a, 610b, and 610c), viewing detectors 620 (620a, 620b, and 620c), a communication section 630, a playback processing section 640, a viewing-information collecting section 650, and a viewing-information storing section 670. The digital signage 610a and the viewing detector 620a make a pair. The digital signage 610b and the viewing detector 620b make a pair. The digital signage 610c and the viewing detector 620c make a pair. It should be noted that the ad indication system 60 may have only one digital signage 610. The digital signages 610, the communication section 630, and the playback processing section 640 are similar to the digital signages 310, the communication section 330, and the playback processing section 340 in FIG. 6, respectively.

Each digital signage 610 includes a display or a projector, and indicates digital contents such as an ad on the display or the projector. Preferably, the digital signages 610 in the ad indication system 60 simultaneously play back a same ad.

Each viewing detector 620 measures the number of people viewing the ad played back by the associated digital signage 610. The viewing detector 620 may be a known detector such as a detector disclosed in Japanese patent application publication number 2008-112401. Preferably, the viewing detector 620 includes a camera for taking a picture of a view area about the associated digital signage 610, a first section for recognizing, from the taken picture, every person in the view area who is viewing an ad played back by the associated digital signage 610, and a second section for counting the persons recognized by the first section.

The view detector 620 may use one of other ways of measuring the number of people viewing a played-back ad. According to a first example, a device for distributing related information or coupons by using NFC (Near Field Communication) is provided adjacently to each digital signage, and communications between the device and portable devices held by viewers are detected to measure the numbers of the viewers. In this case, it is thought that each viewer performs NFC receiving operation with respect to the held portable device while having an interest in a played-back ad, and hence the number of viewers interested in the ad can be accurately measured. According to a second example, sensors detect every person entering a viewing area and every person leaving the viewing area, and the number of people viewing a played-back ad is measured on the basis of the detections by the sensors.

The viewing-information collecting section 650 receives, from the viewing detectors 620a, 620b, and 620c, signals representing the measured numbers of people viewing a played-back ad. The viewing-information collecting section 650 analyzes the received signals to detect viewers (people viewing the played-back ad) and measure a duration or a time interval (an ad-viewed duration or an ad-viewed time interval) for which each of the detected viewers monitors the played-back ad. For all the detected viewers, the viewing-information collecting section 650 sums the ad-viewed durations (time intervals) in a prescribed term such as one day or one week to obtain a total ad-viewed time. The viewing-information collecting section 650 stores the obtained total ad-viewed time into the viewing-information storing section 670. For example, in the case where 10 detected viewers are one hour in ad-viewed time and 8 detected viewers are two hours in ad-viewed time, the total ad-viewed time is 26 hours (=1×10+2×8).

At a prescribed timing, the viewing-information collecting section 650 transfers the total ad-viewed time from the viewing-information storing section 670 to the communication section 630, and the communication section 630 sends a viewing information piece representative of the obtained total ad-viewed time to the ad distribution planning apparatus 50 via the communication network 40. Preferably, the communication section 630 adds, to the viewing information piece, the ID of the related business enterprise as a sender ID.

The ad indication system 60 may include a computer system having a combination of a CPU, a ROM, a RAM, and an input/output port. The computer system operates in accordance with a computer program in the ROM or the RAM. The computer program may be designed to enable the computer system to serve as at least one of the communication section 630, the playback processing section 640, the viewing-information collecting section 650, and the viewing-information storing section 670.

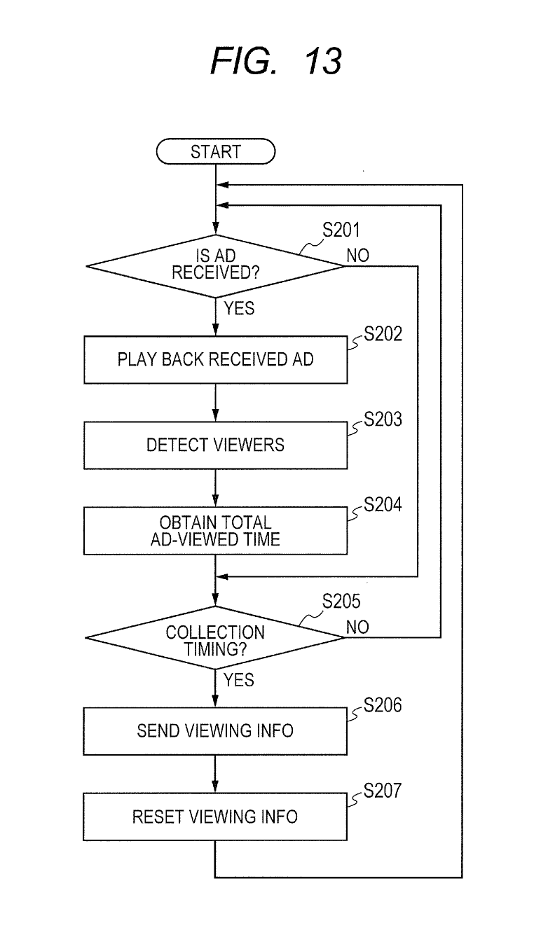

FIG. 13 is a flowchart of operation of the ad indication system 60 which may be implemented by the computer program for the computer system therein. Preferably, the ad distribution planning apparatus 50 distributes an ad or ads on a real-time basis. In this case, an ad to be played back by the business enterprise “A” at 10:00:00 is distributed to the business enterprise “A” from the ad distribution planning apparatus 50 at 10:00:00. A time lag may be considered for the distribution of the ad. Each ad may be distributed in advance while the time for which the ad should be played back is designated.

With reference to FIG. 13, the first step S201 in the operation decides whether or not an ad distributed from the ad distribution planning apparatus 50 is received by the communication section 630. When an ad is received, the operation advances from the step S201 to a step S202. Otherwise, the operation jumps from the step S201 to a step S205.

The step S202 subjects data (digital data) representative of the received ad to signal processing for ad playback to generate processing-resultant data, and feeds the processing-resultant data to the digital signage or signages 610. The step S202 controls the digital signage or signages 310 to indicate the ad represented by the processing-resultant data.

A step S203 following the step S202 refers to the signal or signals from the viewing detector or detectors 620 and continues to detect the instantaneous number of viewers about the ad indicated by the digital signage or signages 610. A step S204 subsequent to the step S203 integrates the detected instantaneous viewer number for the duration of the indication of the ad to obtain a total ad-viewed time. The step S204 stores the obtained total ad-viewed time into the viewing-information storing section 670. After the step S204, the operation advances to the step S205.

The sequence of the steps S202, S203, and S204 is done each time an ad is distributed from the ad distribution planning apparatus 50.

The steps S203 and 204 may be modified to take the following actions. The step S203 refers to the signal or signals from the viewing detector or detectors 620 and thereby detects the current number of viewers about the ad indicated by the digital signage or signages 610. The step S204 multiplies the detected current viewer number by a time unit to calculate a current portion of a total ad-viewed time. The step S204 adds the current portion to the total ad-viewed time in the viewing-information storing section 670 to renew the total ad-viewed time. In other words, the step S204 updates the total ad-viewed time in the viewing-information storing section 670. The sequence of the steps S203 and S204 is iterated until the indication of the ad ends. When the indication of the ad ends, the operation advances from the step S204 to the step S205.

The step S205 decides whether or not the present time reaches a prescribed collection timing. When the present time reaches the prescribed collection timing, the operation advances from the step S205 to a step S206. Otherwise, the operation returns from the step S205 to the step S201.

The step S206 reads out the total ad-viewed time from the viewing-information storing section 670. The step S206 sends a viewing information piece representative of the read-out total ad-viewed time to the ad distribution planning apparatus 50 via the communication network 40. Preferably, the step S206 adds, to the viewing information piece, the ID of the related business enterprise as a sender ID.

A step S207 following the step S206 resets the total ad-viewed time in the viewing-information storing section 670. After the step S207, the operation returns to the step S201.

Accordingly, when the ad indication system 30 receives an ad distributed from the ad distribution planning apparatus 50 (the step S201), the playback processing section 640 subjects data representative of the received ad to signal processing for ad playback to generate processing-resultant data, and feeds the processing-resultant data to the digital signage or signages 610. The playback processing section 640 controls the digital signage or signages 610 to indicate and play back the ad represented by the processing-resultant data (the step S202).

The viewing detector or detectors 620 measure the numbers of viewers about the ad indicated by the associated digital signage or signages 610, respectively. The viewing detector or detectors 620 output a signal or signals representative of the measured viewer number or numbers to the viewing-information collecting section 650. The viewing-information collecting section 650 refers to the signal or signals from the viewing detector or detectors 620 and continues to detect the instantaneous total number of viewers about the ad indicated by the digital signage or signages 610 (the step S203). The viewing-information collecting section 650 integrates the detected instantaneous total viewer number for the duration of the indication of the ad to obtain a total ad-viewed time. In this case, it is unnecessary to identify the viewers. The viewing-information collecting section 650 stores the obtained total ad-viewed time into the viewing-information storing section 670 (the step S204). The sequence of these actions is done each time an ad is distributed from the ad distribution planning apparatus 50.

The viewing-information collecting section 650 may be modified to take the following actions. The viewing-information collecting section 650 refers to the signal or signals from the viewing detector or detectors 620 and thereby detects the current number of viewers about the ad indicated by the digital signage or signages 610. The viewing-information collecting section 650 multiplies the detected current viewer number by a time unit to calculate a current portion of a total ad-viewed time. The viewing-information collecting section 650 adds the current portion to the total ad-viewed time in the viewing-information storing section 670 to renew the total ad-viewed time. In other words, the viewing-information collecting section 650 updates the total ad-viewed time in the viewing-information storing section 670. The sequence of these actions is iterated until the indication of the ad ends.

When the present time reaches a prescribed collection timing (the step S205), the viewing-information collecting section 650 transfers the total ad-viewed time from the viewing-information storing section 670 to the communication section 630. The communication section 630 sends a viewing information piece representative of the total ad-viewed time to the ad distribution planning apparatus 50 via the communication network 40 (the step S206). Preferably, the communication section 630 adds, to the viewing information piece, the ID of the related business enterprise as a sender ID. Preferably, the prescribed collection timing is per day or week. The prescribed collection timing is common to all the ad indication systems 60a, 60b, 60c, . . . in the business enterprises “A”, “B”, “C”, . . . . Thereafter, the viewing-information storing section 670 resets the total ad-viewed time in the viewing-information storing section 670 (the step S207).

The ad distribution planning apparatus 50 receives a viewing information piece representative of a total ad-viewed time from each of the ad indication systems 60a, 60b, 60c, . . . in the business enterprises “A”, “B”, “C”, . . . via the communication network 40. In the ad distribution planning apparatus 50, the received total ad-viewed time is transferred to the viewing-information receiving section 540 from the communication section 530. The viewing-information receiving section 540 refers to the business enterprise information table 550 or the distribution information table 570, and thereby detects the ID of a source business enterprise (an ad-playback business enterprise or a distribution-destination business enterprise) sending the total ad-viewed time. Preferably, the viewing-information receiving section 540 extracts a sender ID from the received viewing information piece, and collates the extracted sender ID with the business enterprise information table 550 or the distribution information table 570 to identify the source business enterprise. The viewing-information receiving section 540 stores the received total ad-viewed time into the viewing information table 580 (FIG. 11) while adding the ID of the identified business enterprise (the ad-playback business enterprise) thereto.

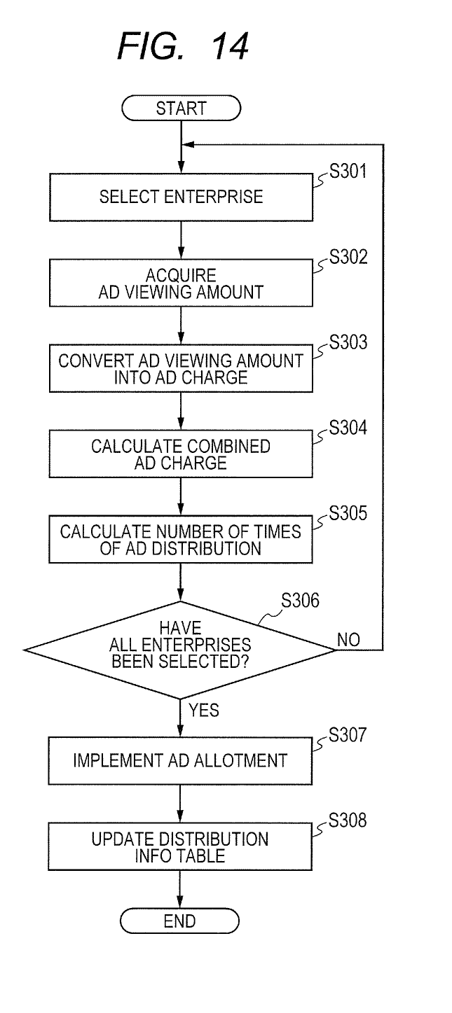

A description will be given below of operation of the ad distribution planning apparatus 50 for making an ad distribution plan or scheme. The ad distribution planning apparatus 50 operates in accordance with the computer program stored therein. FIG. 14 is a flowchart of the plan making operation of the ad distribution planning apparatus 50 which is implemented by a segment of the computer program. Preferably, the plan making operation is started when viewing information pieces each representative of a total ad-viewed time have been received from all the ad indication systems 60 in the business enterprises “A”, “B”, “C”, . . . . Thus, the distribution information table 570 denoting an ad distribution plan or scheme is updated at every moment equal to the prescribed collection timing for the ad indication systems 60.

With reference to FIG. 14, the first step S301 of the plan making operation selects one from the business enterprises “A”, “B”, “C”, . . . . The step S301 is designed to sequentially select the business enterprises “A”, “B”, “C”, . . . as it is iterated. A step S302 following the step S301 acquires an ad viewing amount for the selected business enterprise from the viewing information table 580 (FIG. 11). The acquired ad viewing amount is the total ad-viewed time for the selected business enterprise.

A step S303 following the step S302 converts the ad viewing amount for the selected business enterprise into a conversion-result ad charge according to a prescribed rule. The step S303 is similar to the step S103 in FIG. 7. A step S304 subsequent to the step S303 calculates a combined ad charge from the conversion-result ad charge and the paid ad charge in the business enterprise information table 550 for the selected business enterprise. The step S304 is similar to the step S104 in FIG. 7.

A step S305 following the step S304 calculates the number of times of implementation of ad distribution from the combined ad charge for the selected business enterprise. The step S305 is similar to the step S105 in FIG. 7. A step S306 subsequent to the step S305 decides whether or not all the business enterprises “A”, “B”, “C”, . . . have been selected by the step S301. When all the business enterprises “A”, “B”, “C”, . . . have been selected, the operation advances from the step S306 to a step S307. Otherwise, the operation returns from the step S306 to the step S301.

The step S307 implements ad allotment for each of advertiser business enterprises by referring to the calculated number of times of implementation of ad distribution, the ad playback time ranges in the business enterprise information table 550, and the ad information table 560. The step S307 is similar to the step S107 in FIG. 7. A step S308 following the step S307 updates the distribution information table 570 in accordance with the implemented ad allotment. After the step S308, the plan making operation ends.

In the plan making operation, the ad-viewing-amount acquiring section 511 selects one from the business enterprises “A”, “B”, “C”, . . . (the step S301). Then, the ad-viewing-amount acquiring section 511 acquires an ad viewing amount for the selected business enterprise from the viewing information table 580 in FIG. 11 (the step S302). The acquired ad viewing amount is the total ad-viewed time for the selected business enterprise.

Subsequently, the combined-ad-charge calculating section 512 converts the ad viewing amount for the selected business enterprise into a conversion-result ad charge according to a prescribed rule (the step S303). Then, the combined-ad-charge calculating section 512 calculates a combined ad charge from the conversion-result ad charge and the paid ad charge in the business enterprise information table 550 for the selected business enterprise (the step S304).

Then, the ad allotting section 513 calculates the number of times of implementation of ad distribution from the combined ad charge for the selected business enterprise (the step S305).

The above-mentioned actions by the ad-viewing-amount acquiring section 511, the combined-ad-charge calculating section 512, and the ad allotting section 513 are iterated while the selected business enterprise is repetitively changed from one to another (the steps S306 and S301). Thus, the above-mentioned actions are implemented with respect to all the business enterprises “A”, “B”, “C”, . . . . Accordingly, the number of times of implementation of ad distribution is calculated for each of the advertisers formed by the business enterprises “A”, “B”, “C”, . . . respectively.

Thereafter, the ad allotting section 513 implements ad allotment for each of advertiser business enterprises by referring to the calculated number of times of implementation of ad distribution, the ad playback time ranges in the business enterprise information table 550, and the ad information table 560 (the step S307). Subsequently, the ad allotting section 513 updates the distribution information table 570 in accordance with the implemented ad allotment (the step S308). Thereafter, the plan making operation ends.

The second embodiment of this invention has an advantage similar to that of the first embodiment thereof. In the second embodiment of this invention, more accurate ad viewing amounts are available so that a better ad distribution scheme can be implemented.

What is claimed is:

1. A mutually advertising system comprising:
an ad distribution planning apparatus; and
a plurality of ad indication systems connected with the ad distribution planning apparatus via a network and possessed by business enterprises respectively, wherein each of the ad indication systems plays back an ad distributed from the ad distribution planning apparatus;
wherein the ad distribution planning apparatus comprises an ad-viewing-amount calculating section for, with respect to each of the business enterprises, calculating an ad viewing amount from the number of viewers about the ad indication system possessed by the business enterprise and a time range during which an ad is played back by the ad indication system possessed by the business enterprise, and a combined-ad-charge calculating section for, with respect to each of the business enterprises, converting the ad viewing amount calculated by the ad-viewing-amount calculating section into a conversion-result ad charge according to a prescribed rule and calculating a combined ad charge from the conversion-result ad charge and a paid ad charge; and
wherein the ad distribution planning apparatus further comprises an ad allotting section for setting distribution of an ad of each of the business enterprises to the ad indication systems on the basis of the combined ad charge calculated by the combined-ad-charge calculating section.

2. An ad distribution planning apparatus connected with a plurality of ad indication systems of respective business enterprises via a network, wherein each of the ad indication systems plays back an ad distributed from the apparatus, the apparatus comprising:
an ad-viewing-amount calculating section for, with respect to each of the business enterprises, calculating an ad viewing amount from the number of viewers about the ad indication system of the business enterprise and a time range during which an ad is played back by the ad indication system of the business enterprise;
a combined-ad-charge calculating section for, with respect to each of the business enterprises, converting the ad viewing amount calculated by the ad-viewing-amount calculating section into a conversion-result ad charge according to a prescribed rule and calculating a combined ad charge from the conversion-result ad charge and a paid ad charge; and
an ad allotting section for setting distribution of an ad of each of the business enterprises to the ad indication systems on the basis of the combined ad charge calculated by the combined-ad-charge calculating section.

3. A mutually advertising system comprising:
an ad distribution planning apparatus; and
a plurality of ad indication systems connected with the ad distribution planning apparatus via a network and possessed by business enterprises respectively;
wherein each of the ad indication systems comprises a digital signage for indicating an ad distributed from the ad distribution planning apparatus, and a viewing-information collecting section for calculating an ad viewing amount from the number of viewers about an ad indicated by the digital signage and time intervals during which the viewers monitor the ad indicated by the digital signage respectively, and for sending the calculated ad viewing amount to the ad distribution planning apparatus; and
wherein the ad distribution planning apparatus comprises a combined-ad-charge calculating section for, with respect to each of the business enterprises, converting the ad viewing amount sent from the ad indication system possessed by the business enterprise into a conversion-result ad charge according to a prescribed rule and calculating a combined ad charge from the conversion-result ad charge and a paid ad charge, and an ad allotting section for setting distribution of an ad of each of the business enterprises to the ad indication systems on the basis of the combined ad charge calculated by the combined-ad-charge calculating section.

4. An ad distribution planning apparatus connected with a plurality of ad indication systems of respective business enterprises via a network, wherein each of the ad indication systems indicates an ad distributed from the apparatus, the apparatus comprising:
a viewing-information receiving section for receiving ad viewing amounts from the ad indication systems respectively, wherein each of the viewing amounts depends on the number of viewers about an ad indicated by the related ad indication system and time intervals during which the viewers monitor the ad indicated by the related ad indication system respectively;
a combined-ad-charge calculating section for, with respect to each of the business enterprises, converting the related ad viewing amount received by the viewing-information receiving section into a conversion-result ad charge according to a prescribed rule and calculating a combined ad charge from the conversion-result ad charge and a paid ad charge; and
an ad allotting section for setting distribution of an ad of each of the business enterprises to the ad indication systems on the basis of the combined ad charge calculated by the combined-ad-charge calculating section.

5. A method of planning the distribution of ads, comprising the steps of:
with respect to each of business enterprises possessing respective ad indication systems for playing back a distributed ad, calculating an ad viewing amount from the number of viewers about the ad indication system possessed by the business enterprise and a time range during which an ad is played back by the ad indication system possessed by the business enterprise;
with respect to each of the business enterprises, converting the calculated ad viewing amount into a conversion-result ad charge according to a prescribed rule and calculating a combined ad charge from the conversion-result ad charge and a paid ad charge; and
setting distribution of an ad of each of the business enterprises to the ad indication systems on the basis of the calculated combined ad charge.

6. A method of planning the distribution of ads, comprising the steps of:
receiving ad viewing amounts from respective ad indication systems of business enterprises, wherein each of the viewing amounts depends on the number of viewers about an ad indicated by the related ad indication system and time intervals during which the viewers monitor the ad indicated by the related ad indication system respectively;
with respect to each of the business enterprises, converting the related received ad viewing amount into a conversion-result ad charge according to a prescribed rule and calculating a combined ad charge from the conversion-result ad charge and a paid ad charge; and
setting distribution of an ad of each of the business enterprises to the ad indication systems on the basis of the calculated combined ad charge.

7. A computer program for enabling an information processing apparatus to function as:
an ad-viewing-amount calculating section for, with respect to each of business enterprises possessing respective ad indication systems, calculating an ad viewing amount from the number of viewers about the ad indication system of the business enterprise and a time range during which an ad is played back by the ad indication system of the business enterprise;
a combined-ad-charge calculating section for, with respect to each of the business enterprises, converting the ad viewing amount calculated by the ad-viewing-amount calculating section into a conversion-result ad charge according to a prescribed rule and calculating a combined ad charge from the conversion-result ad charge and a paid ad charge; and
an ad allotting section for setting distribution of an ad of each of the business enterprises to the ad indication systems on the basis of the combined ad charge calculated by the combined-ad-charge calculating section.

8. A computer program for enabling an information processing apparatus to function as:
a viewing-information receiving section for receiving ad viewing amounts from indication systems of business enterprises respectively, wherein each of the viewing amounts depends on the number of viewers about an ad indicated by the related ad indication system and time intervals during which the viewers monitor the ad indicated by the related ad indication system respectively;
a combined-ad-charge calculating section for, with respect to each of the business enterprises, converting the related ad viewing amount received by the viewing-information receiving section into a conversion-result ad charge according to a prescribed rule and calculating a combined ad charge from the conversion-result ad charge and a paid ad charge; and
an ad allotting section for setting distribution of an ad of each of the business enterprises to the ad indication systems on the basis of the combined ad charge calculated by the combined-ad-charge calculating section.
